(19) United States
(12) Patent Application Publication
(10) Pub. No.: US 2006/0221493 A1
(43) Pub. Date: Oct. 5, 2006

(54) Coined features including material flow openings

(75) Inventors: WaiOnn Chee, Singapore (SG); BoonSeng Ong, Singapore (SG)

Correspondence Address: Deirdre Megley Kvale;Westman, Champlin & Kelly, Suite 1600, 900 Second Avenue South, Minneapolis, MN, 55402-3319, US

(73) Assignee: Seagate Technology LLC, Scotts Valley, CA (US)

(21) Appl. No.: 11/095,219

(22) Filed: Mar. 31, 2005

(51) Int. Cl. G11B 17/00

(52) U.S. Cl. 360/97.01

(57) ABSTRACT

A housing or cover having a coined region or regions to provide additional clearance or height within form factor dimensions of the housing or cover. In embodiments described, the housing or cover includes coined regions which have a smaller body thickness dimension than a stock thickness of the housing or cover to provide additional clearance. The coined regions include openings, slots or holes to provide a collection site for material removed from the coined regions to form the smaller body thickness dimension.

### FIELD OF THE INVENTION

The present invention relates generally to coined features, and more particularly but not by limitation, to coined features for providing clearance for form factor dimensions of a data storage device.

### BACKGROUND OF THE INVENTION

Data storage devices store digital information on a data storage medium, such as a magnetic disc. Such devices include heads to read data from and/or write data to the data storage medium or disc. Heads are coupled to an actuator to position the heads relative to tracks on the disc. The heads, actuator, disc(s) and other components of the device are enclosed within a housing. The housing is sized to conform to standardized form factor dimensions.

As form factor dimensions decrease there is a need to provide additional clearance for the operating components of the device without compromise to the structural integrity of the device. Embodiments of the present invention provide solutions to these and other problems, and offer other advantages over the prior art.

### SUMMARY OF THE INVENTION

The present invention relates to a housing or cover having a coined region or regions to provide additional clearance within form factor dimension of the housing. In embodiments described, the housing or cover includes a coined region or regions which have a smaller body thickness dimension than a stock thickness of the housing or cover to provide additional clearance. The coined region or regions include openings to provide a collection site for material removed from the coined region to form the smaller body thickness dimension. This enables fabrication of the coined region having a relatively large coining depth to provide clearance for a form factor housing or cover. Other features and benefits that characterize embodiments of the present invention will be apparent upon reading the following detailed description and review of the associated drawings.

### BRIEF DESCRIPTION OF THE DRAWINGS

FIG. 1A schematically illustrates a form factor housing for Part A.

FIG. 1B schematically illustrates a form factor housing including a coined feature.

FIG. 1C schematically illustrates a form factor housing including a coined region having a flow opening.

FIG. 1D schematically illustrates a form factor housing including a plurality of coined regions having flow openings and different coined depths.

FIG. 2 is an exploded view of an embodiment of a data storage device including a cover having coined features.

FIG. 3 is a cross-sectional view taken along line 3-3 of FIG. 2.

FIG. 4 is a plan view of an embodiment of an inner surface of the cover of FIG. 2 including coined features.

FIG. 4A is a sectional view along line 4A-4A of FIG. 4.

FIG. 4B is a sectional view along line 4B-4B of FIG. 4.

FIG. 4C is a sectional view along line 4C-4C of FIG. 4.

FIG. 5 is a plan view of another embodiment of an inner surface of a cover including coined features.

FIG. 6 is a flow chart illustrating process steps for fabrication of coined features of the present invention.

### DETAILED DESCRIPTION OF ILLUSTRATIVE EMBODIMENTS

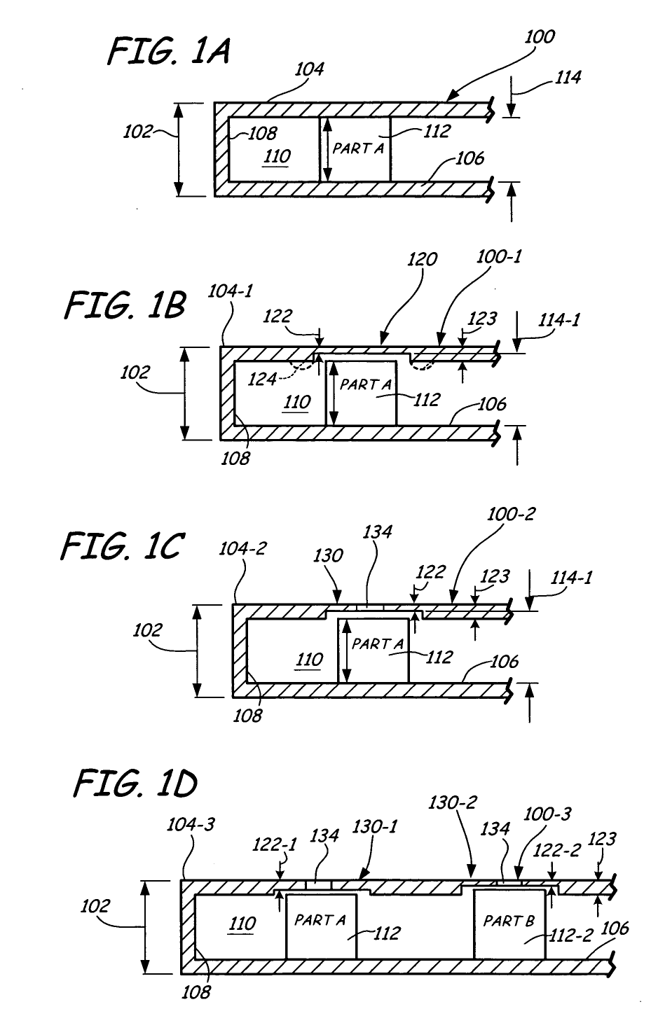

FIG. 1A illustrates a housing 100 for components of a device for example a data storage device. The housing 100 has a design height envelope or dimension 102 which is limited by standardized form factor dimensions. As shown in FIG. 1A, the housing 100 includes a top or first portion 104, a bottom or second portion 106 and perimeter wall portion 108 which cooperatively form a housing chamber 110 of the housing 100. In the illustrated embodiment, the bottom portion 106 of the housing forms a chassis or base to which Part A 112 is assembled. The thickness or dimension of the top portion 104, bottom portion 106 and chamber 110 cumulatively define a height or dimension of the device or housing. The cumulative height or dimension of the housing 100 must not exceed the form factor dimension 102.

As shown, Part A 112 is disposed in the housing chamber 110 between the top portion 104 and the bottom portion 106. A height dimension 114 of the chamber 110 must be larger enough to accommodate a height dimension of Part A 112. In addition, the top and bottom portions 104, 106 must have sufficient thickness to provide structural integrity for the housing or device. In the embodiment illustrated, part A requires more clearance than the chamber height or dimension provides for the illustrated form factor height or dimension 102.

FIG. 1B illustrates an embodiment of a housing 100-1 which provides additional clearance for Part A within the form factor dimension 102 of the housing. As shown, the top portion 104-1 of the housing includes a coined region 120 having a smaller body thickness dimension 122 than a stock thickness dimension 123 of the top portion 104-1. The smaller body thickness dimension 122 increases the chamber height dimension 114-1 proximate to part A 112.

A coining process is used to provide a non-uniform thickness for a stamped or sheet metal part. During the coining process, material is displaced from the coined region to provide the smaller body thickness. The coining process is well suited for perimeter features where material displaced by the coining process locates proximate to a perimeter edge and can be easily removed or trimmed. For other features, as illustrated in FIG. 1B, displaced material can collect proximate to a perimeter area of the coined region 120 and form a rim or area of increased thickness 124. This rim or area of increased thickness 124 interferes with a chamber height or dimension outside of the coined region 120.

FIG. 1C illustrates an embodiment of a top portion 104-2 of housing 100-2 including a coined region 130 having a smaller body thickness 122 than the stock thickness 123 to provide an area having an increased chamber height or dimension proximate to the coined region 130. As shown, the coined region 130 has an opening or slot 134 to collect material displaced by the coining process to form the coined region having the reduced or smaller body thickness 122. During the coining process material displaced from the coined region 130 collects in the opening or slots to limit formation of a perimeter rim or region of increased thickness 124 to provide additional clearance without interference with height parameters of the chamber or housing.

In another embodiment illustrated in FIG. 1D, the top portion 104-3 of the housing 100-3 includes multiple coined regions 130-1, 130-2 including material flow openings 134. In the illustrated embodiment, the multiple coined regions 130-1, 130-2 include different coined depths to provide different body thickness relative to the stock thickness 123. As shown, coined region 130-1 includes a smaller body thickness 122-1 than the stock thickness 123 to provide clearance for Part A 112 and coined region 130-2 has a smaller body thickness 122-2 than the body thickness 122-1 of region 130-1 to provide additional clearance for Part B 112-2. As previously described, each of the coined regions 130-1, 130-2 include material flow openings 134 to provide collection sites for material displaced by the coining process. Although FIG. 1D illustrates a particular embodiment, application is not so limited and different coined regions having varied or the same coined depth can be fabricated depending upon the particular application.

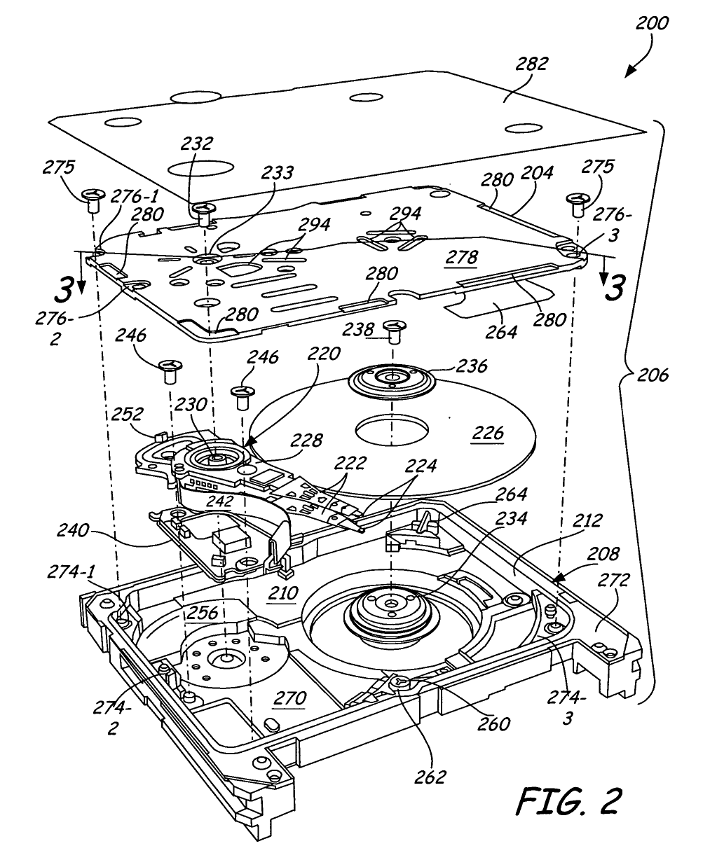

The coined housing of the previous FIGS. has application for increasing clearance or available space for form factor dimensions of a data storage device. For example, the present invention has application for a “1” data storage device 200 as illustrated as FIG. 2. As shown in FIG. 2, the data storage device 200 includes coined regions illustrated in phantom on a cover 204 of the housing 206 for clearance or additional form height. As shown, housing 206 includes the cover 204 and a base 208 which forms a chassis for components of the data storage device. Cover 204 attaches to the base 208 to form a chamber 210 enclosed by a perimeter wall 212 of the base.

The components of the data storage device are assembled to the base 208 and are enclosed with chamber 210 of the housing 206. As shown in the exploded view of FIG. 2, the device includes a head actuator 220 having a plurality of head actuator arms 222. Heads 224 are coupled to the actuator arms 222 to position the heads 224 relative to data tracks on a disc 226. The actuator arms 222 are connected to an actuator block 228 which is rotationally coupled to the base 208 via a bearing assembly 230. As shown fastener 232 extend through opening 233 in cover 204 to secure the head actuator 220 between the cover 204 and base 208.

Disc 226 is rotationally coupled to the base 208 via-a spindle motor assembly 234 connected to the base 208. Disc 226 is secured to spindle motor assembly 234 via clamp 236 and pin 238. In the embodiment shown, drive circuitry includes a printed circuit board (PCB) 240 and flex circuit 242. The PCB 240 is connected to the base 208 via screws or fasteners 246. The flex circuit 242 extends from the PCB 240 to the head actuator 220 to provide an electrically interface for the heads on the actuator arms 222 and to energize a voice coil motor (VCM) to position the heads 224 relative to data tracks on the disc 226.

As shown, the voice coil motor rotates head actuator 220 to position the heads 224 by supplying current to a bobbin 252 on the head actuator 220. The bobbin 252 is interposed in a magnetic field formed between opposed magnetic poles (only magnetic pole 254 fabricated on the base is illustrated in FIG. 2). In the illustrated embodiment, heads 224 are supported by a load/unload ramp 260 during intermittent or non-operational periods. The load/unload ramp 260 is connected to the base via screw or fastener 262. Additionally, in the illustrated embodiment, a breather filter 264 is connected to the base 208 as shown.

As shown, the base 208 includes a floor 270 recessed below raised deck 272 about a perimeter of the base to form the perimeter wall 212. In the illustrated embodiment, the base 208 includes raised shelves 274-1, 274-2, 274-3 which are elevated from the floor 270 of the base and recessed from the deck 272 to form a surface for the cover 204. The cover 204 abuts shelves 274-1, 274-2, 274-3 of the base and is secured to the shelves 274-1, 274-2, 274-3 via screws 275 which extend through embossed pads 276-1, 276-2, 276-3 on the cover to connect the cover to the raised shelves 274-1, 274-2, 274-3.

The recessed dimension of the shelves 247-1, 274-2, 274-3 from the raised deck 272 and embossed dimension of the pads 276-1, 276-2, 276-3 align an outer surface 278 of the cover with an outer surface of the deck 272 when the cover 204 is attached to the base 208. The cover 204 is preferably formed of an aluminum, cold rolled steel, stainless steel or other material. The outer surface 278 of the cover includes a plurality coined edge regions 280 for fabrication. As shown, an outer layer or sheet 282, for example a plastic sheet is assembled over the cover 204 on the deck surface 272 of the base 208.

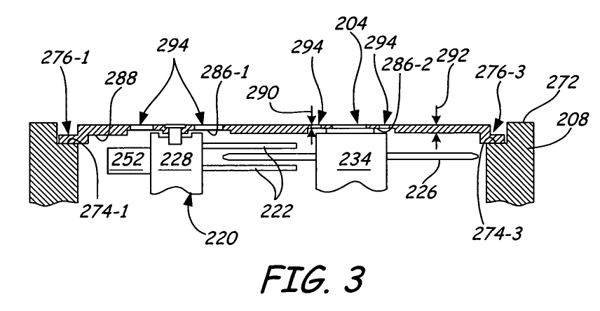

As previously described, the cover includes coined regions as illustrated in phantom in FIG. 2. As shown in FIG. 3, the coined regions form raised coined surfaces 286-1, 286-2 on an inner surface 288 of the cover to provide clearance for components of the data storage device. The coined surfaces are fabricated by a coining process which forms a smaller or reduced body thickness 290 relative to a stock thickness 292 of the cover for areas of the cover. Each of the coined regions includes flow openings 294 to fabricate the reduced body thickness in regions or areas which are not located along a perimeter edge of the cover. As previously described, material displaced by the coining process collects in the openings 294 to form the reduced body thickness 290 relative to the stock thickness 292 of the cover.

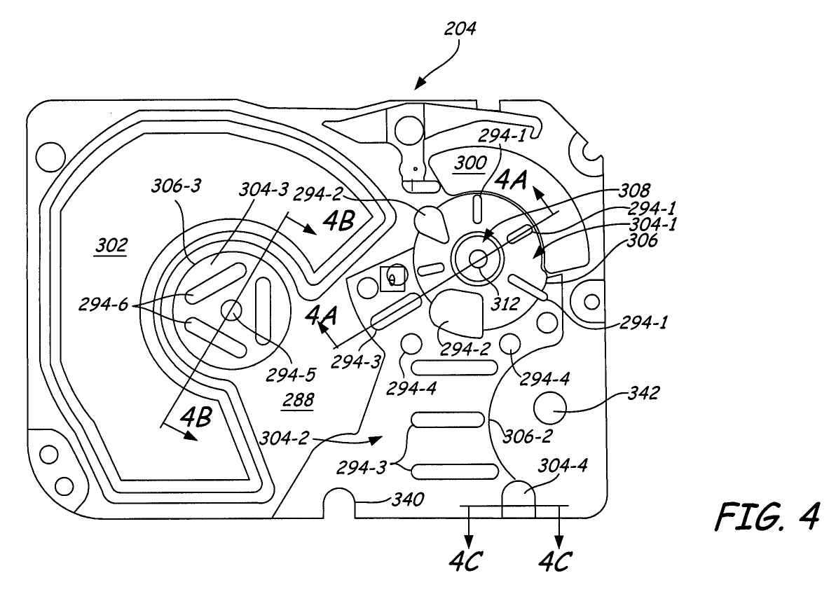

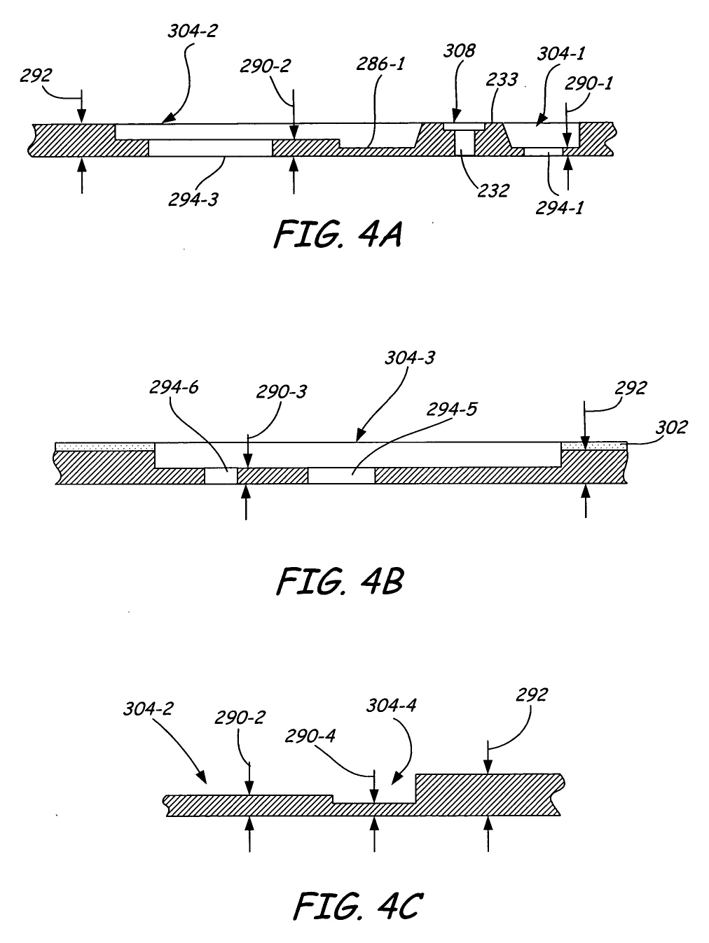

FIG. 4 is a plan view illustrating features of the inner surface 288 of the cover 204 of FIGS. 2 and 3. As shown in FIG. 4, the cover includes a voice coil motor magnet 300 and carbon breather filter 302. The cover includes coined regions 304-1, 304-2, 304-3, 304-4. As shown in FIGS. 4 and 4A, the coined region 304-1 is located proximate to the head actuator 220, not shown in FIG. 4 to form raised surface 286-1 as shown in FIG. 3 proximate to the head actuator 220. Coined region 304-1 has a profile 306 which circumferentially extends about a hub region 308 having a stock body thickness 292. The hub region 308 includes countersunk opening 233 to connect the actuator 220 to the cover as previously described.

As shown in FIG. 4A the coined region 304-1 has a reduced body thickness 290-1 relative to the stock body thickness 292 of the hub region 308 to increase clearance for the head actuator 220. As shown in FIG. 4, the coined region 304-1 includes a plurality of elongate slots 294-1 and bulbous openings 294-2 circumferentially spaced about the hub region 308 to collect material flow to fabricate the reduced body thickness 290-1 about the hub region 308. In the illustrated embodiment, the cover has a stock thickness 292 of approximately 0.5 mm. The coined 304-1 region has a coined depth of approximately 0.175 mm which is more than 10% of the stock thickness which provides more clearance than previous coining applications.

Coined region 304-2 includes a profile 306-2 which extends from the coined region 304-1 to an edge of the cover 204. As illustrated in FIG. 4A, coined region 304-2 has a smaller body thickness 290-2 than the stock thickness 292 of the cover but larger than the body thickness 290-1 of coined region 304-1. Coined region 304-2 provides clearance for drive circuitry (PCB 240 and flex circuit 242) and the load/unload ramp 260. Coined region 304-2 includes a plurality of dispersed slots 294-3 and holes 294-4. As shown the region includes a plurality of spaced transverse slots 294-3 extending from an inner portion of the coined region 304-2 to an edge of the coined region.

As shown in FIGS. 4 and 4B, the cover includes coined region 304-3 having a reduced body thickness 290-3 to form the raised surface 286-2 proximate to the spindle motor as shown in FIG. 3. As shown, coined region 304-3 has a profile 306-3 and includes an opening 294-5 and transverse slots 294-6 circumferentially spaced about opening 294-5 for material flow. In an illustrated embodiment, the coined depth of region 304-3 is approximately 0.250 mm. As shown in FIG. 4, the cover includes edge slot 340 to provide clearance for fastener 262 of the load/unload ramp 260 and opening 342. Additionally the inner surface 288 includes coined region 304-4 for clearance. Coined region 304-4 has a smaller body thickness 290-4 than the body thickness 290-2 of region 304-2 as illustrated in FIG. 4C.

The size, shape and pattern of the openings 294 of the coined regions are designed to optimize material collection while maintaining structural integrity of the cover. The size of the opening is determined based upon the volume of material flow for the coined depth desired. Although a particular pattern of slots or openings is shown, alternate patterns or combinations can be used to maximize material flow or collection. For example as illustrated in FIG. 4, bulbous openings and elongate slots provide additional areas for material flow to achieve a desired coining depth to provide additional clearance or height.

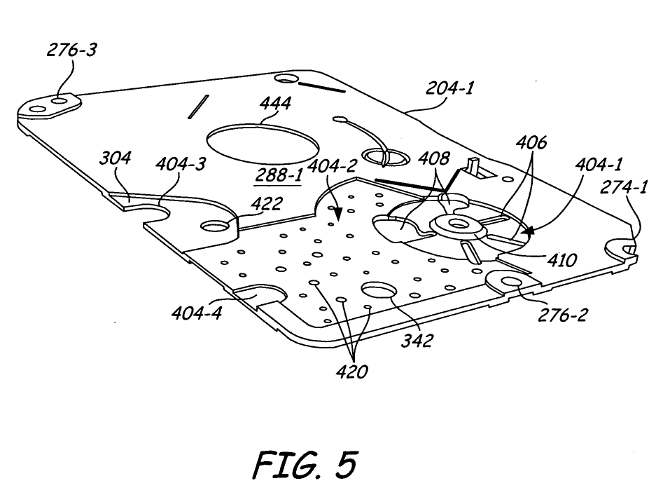

FIG. 5 illustrates another embodiment of a cover 204-1 where like numbers are used to refer to like parts in the previous FIGS. As shown an inner surface 288-1 of cover 204-2 includes coined regions 404-1, 404-2, 404-3, 404-4 to provide clearance. As shown coined region 404-1 has a reduced body thickness and includes slots 406 and bulbous openings 408 spaced about hub portion 410 for the head actuator 220. Coined region 404-2 has a profile as shown in FIG. 5 and a reduced body thickness smaller than the stock thickness of the cover but larger than the body thickness of region 404-1. As shown, region 404-2 includes a plurality of dispersed holes 420 to accommodate material flow for the coined region. The plurality of holes cumulatively provides sufficient material flow areas while limiting effect to the overall structural integrity of the cover 204-1.

Coined regions 404-3 and 404-4 have a reduced body thickness smaller than region 404-2. The reduced body thickness of coined region 404-3 provides clearance for unload/load ramp 260 and fasteners. Coined region 404-3 includes opening 422 for fabrication of the coined body thickness. The cover also includes openings 444 to provide clearance for the spindle motor assembly 234 and clamp 236.

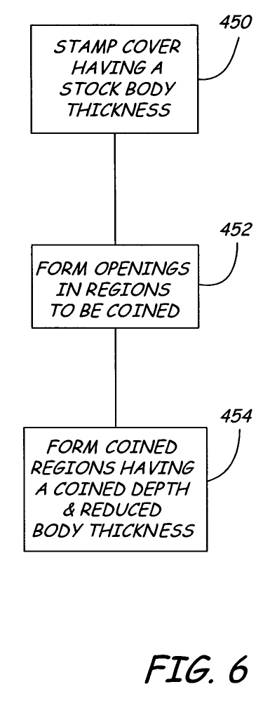

FIG. 6 illustrates an embodiment of process steps for fabrication of coined features of the present invention. In the illustrated embodiment, the coined features are formed on a cover stamped from a sheet metal or stock material having a stock body thickness as illustrated by block 450. The stock material or sheet is stamped to form a perimeter contour of the cover. As illustrated by block 452, openings, slots and/or holes are cut in a region or regions that will be coined for example using a patterned die. The openings, slots and/or holes are cut to provide areas for material flow during the coining process or step. As illustrated in step 454, a coined region is formed having a coined depth and a reduced body thickness. Additionally, in the embodiment of the cover illustrated in FIGS. 4 and 5, the process steps includes a fabrication step to punch or form the pads 274-1, 274-2, 274-3 to connect the cover to the base.

In process embodiments, multiple stamping and cutting steps or stations are used to form the perimeter edge and multiple openings in the body of the cover, however, fabrication is not limited to a specific sequence of steps. For example, the opening or openings can be cut prior to stamping or forming a perimeter contour of the cover. Alternatively multiple steps can be performed concurrently. In FIG. 6, the process is described with respect to stamping but application of the present invention is not limited to stamping and can be used with other sheet metal processes such as blanking or drawing to form a cover or housing having a standard body thickness and coined regions of reduced body thickness.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application, while maintaining substantially the same functionality without departing from the scope and spirit of the present invention. In addition, although the preferred embodiment described herein is directed to a data storage, it will be appreciated by those skilled in the art that the teachings of the present invention can be applied to different application, such as optical storage devices, without departing from the scope and spirit of the present invention.

What is claimed is:

1. A cover for a data storage device comprising:
a cover body having a stock body thickness between opposed surfaces; and
a coined region on a portion of the cover body having a coined body thickness smaller than the stocked body thickness and the coined region including at least one opening between the opposed surfaces of the cover body.

2. The cover of claim 1 wherein the cover including a plurality of coined regions having the smaller coined body thickness.

3. The cover of claim 2 wherein the plurality of coined regions includes a first coined region having a first coined body thickness and a second coined region having a second coined body thickness where the second coined body thickness is smaller than the first coined body thickness.

4. The cover of claim 1 wherein the cover includes the coined region proximate to a head actuator extending about a hub portion for the head actuator and the hub portion having the stock body thickness and the coined body thickness of the coined region proximate to the head actuator is smaller than the stock body thickness of the hub portion.

5. The cover of claim 4 wherein the coined region proximate to the head actuator includes a plurality slots spaced about the hub portion to form the at least one opening in the coined region.

6. The cover of claim 1 wherein the cover includes the coined region proximate to a flex circuit or circuit having the coined body thickness smaller than the stock body thickness.

7. The cover of claim 6 wherein the cover includes a plurality of coined regions including the coined region proximate to the flex circuit or circuit and a coined region proximate to a head actuator and the coined region proximate to the head actuator has a smaller coined body thickness than the coined body thickness of the coined region proximate to the flex circuit or circuit.

8. The cover of claim 1 wherein the coined region includes a plurality of holes or slots spaced in the coined region.

9. The cover of claim 1 wherein the cover includes the coined region proximate to a ramp portion for a load/unload ramp of a data storage device.

10. The cover of claim 1 wherein the cover includes the coined region proximate to a spindle motor of a data storage device including the coined body thickness smaller than the stock body thickness of the cover.

11. The cover of claim 1 wherein the coined body thickness forms a coined depth of approximately 10% or greater of the stock body thickness of the cover.

12. The cover of claim 1 and further including at least one opening in a region of the cover having the stock body thickness.

13. A fabrication method comprising the steps of:
stamping a stock material to form a housing body having body perimeter and a stock body thickness;
cutting at least one opening or hole in a region of the housing body; and
coining a smaller body thickness in the region of the housing body having the at least one opening or hole.

14. The fabrication method of claim 13 wherein the step of coining the smaller body thickness comprises the steps of:
coining a first region in the housing body having a first coining thickness; and
coining a second region in the housing body having a second coining thickness smaller than the first coining thickness.

15. The fabrication method of claim 13 wherein the step of stamping the cover is performed prior to cutting the at least one opening or hole.

16. The fabrication method of claim 13 and further comprising the steps
assembling the cover to a data storage device; and
assembling an outer sheet or layer to a deck of the data storage device over the cover.

17. The fabrication method of claim 13 wherein the steps of stamping, cutting and coining are performed in separate steps at multiple fabrication stations.

18. A housing comprising:
a housing body including a body perimeter and stocked body thickness; and
at least one coined region in the housing body having a coined thickness dimension smaller than the stock body thickness and the coined region having at least one flow opening or a plurality of flow openings.

19. The housing of claim 18 wherein the coined thickness dimension provides a coined depth which is approximately 10% or greater of the stock body thickness of the housing.

20. The housing of claim 18 wherein the housing includes multiple coined regions including a first coined region having a first coined body thickness and a second coined region having a second coined body thickness where the second coined body thickness is smaller than the first coined body thickness.
